(19) United States
(12) Patent Application Publication
(10) Pub. No.: US 2014/0045590 A1
(43) Pub. Date: Feb. 13, 2014

(54) DRAWING GAME WITH RANDOMIZED DRAWING PROMPTS

(71) Applicants: Kim SMITH-STOUT, Little Rock, AR (US); Janet Hanson, Little Rock, AR (US)

(72) Inventors: Kim SMITH-STOUT, Little Rock, AR (US); Janet Hanson, Little Rock, AR (US)

(21) Appl. No.: 13/960,671

(22) Filed: Aug. 6, 2013

Related U.S. Application Data
(60) Provisional application No. 61/682,686, filed on Aug. 13, 2012.

(51) Int. Cl. A63F 13/00

(52) U.S. Cl. CPC A63F 13/00
USPC 463/31

(57) ABSTRACT

A drawing game with randomized drawing prompts is disclosed. Some embodiments include a set of a foundational drawing prompts, a set of embellishing drawing prompts with at least one of the embellishing prompts being dependent on at least one of the foundational prompts, and a set of orientation drawing prompts, each of the orientation drawing prompts operable to provide an orientation to any of the foundational and embellishing prompts when paired with any of the foundational or embellishing prompts.

### CROSS-REFERENCE TO RELATED APPLICATIONS

This application claims the benefit of U.S. Provisional Application No. 61/682,686, filed Aug. 13, 2012, which application is hereby incorporated herein by reference in its entirety.

### BACKGROUND

Many games have been designed around the action of drawing or sketching and may include elements of drama or creative writing. Additionally, many games include play elements of “winner vs. loser” competition based on player skill; time restraints on which a drawing can be completed; limiting image options that may be drawn; the necessity for other players to interpret meaning behind a drawing; or a ruling that a drawing either correctly or incorrectly represents an intended image.

For example in some drawing games, players are asked to draw original or add-on elements to images that represent words, phrases, actions, or categories of people, places or things and to do so with one or more of the elements as discussed above.

The high level of popularity in games that involve drawing or sketching indicates the general market interest in drawing or sketching as a desirable form of entertainment. However, limiting the game platform, and specifically the drawing component of the game, to the above mentioned contexts fails to provide a drawing creator the opportunity to produce works that can more completely demonstrate the players current level of drawing skills or produce a sense of encouragement necessary to foster further exploration of their drawing capabilities and to fully capitalize on their natural creativity as a human. In fact, the aspects of many drawing games are more likely to generate critical assessments and a sense of discouragement regarding ones artistic capacities; with such outcomes especially impacting any individual who may harbor previous negative notions or anxieties regarding their inherent aptitude for drawing.

Additionally, the link of the drawing experience to a particular outcome of winning or losing a given turn or game based on the ability of other players to accurately interpret the drawing presented creates an environment where the player's level of drawing skills are subjected to player critique and scrutiny; often resulting in the message that the creator is somehow inadequate and as a result, generates an adverse reaction to ongoing play.

Accordingly, existing drawing games fail to adequately address the artistic, developmental and self-esteem needs of players as discussed above.

### BRIEF DESCRIPTION OF THE DRAWINGS

FIG. 1 depicts the faces of a foundation die, an embellishing die, and an orientation die in accordance with one embodiment.

FIG. 2 depicts a play-card that includes a drawing area and a drawn-prompt score area in accordance with one embodiment.

FIG. 3 depicts a method of playing a game having randomized drawing prompts in accordance with an embodiment.

FIG. 4 depicts a randomized drawing prompt game system having a first and second user device and a game server operably connected via a network in accordance with an embodiment.

FIG. 5 is a data flow diagram of data flow between a game server and a first user device during a portion of a randomized drawing prompt game in accordance with an embodiment.

FIG. 6 is a data flow diagram of data flow between a game server and a first user device during another portion of a randomized drawing prompt game in accordance with an embodiment.

### DETAILED DESCRIPTION

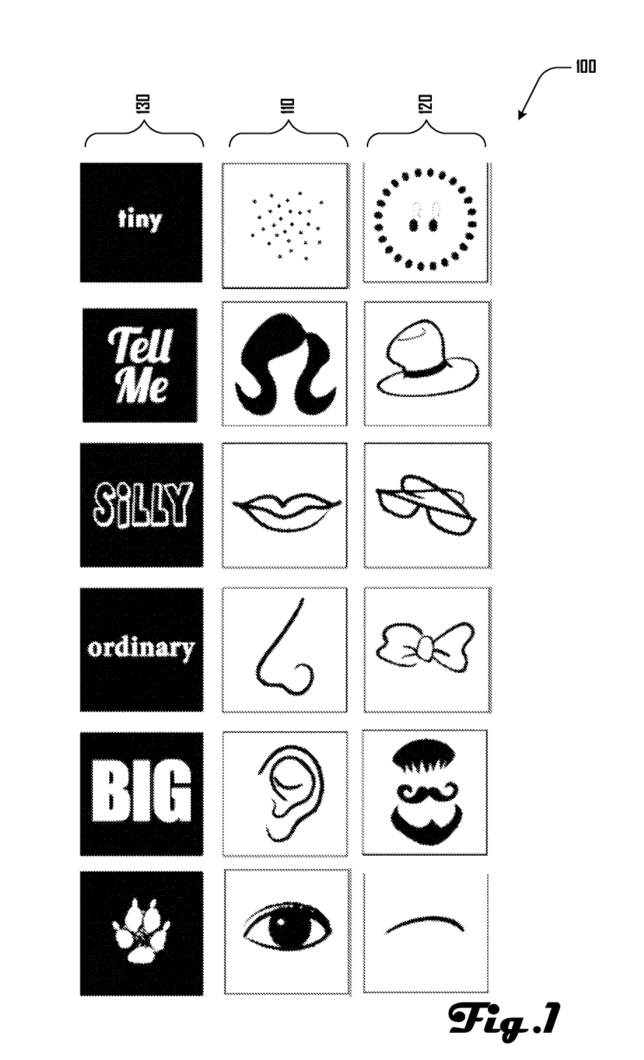

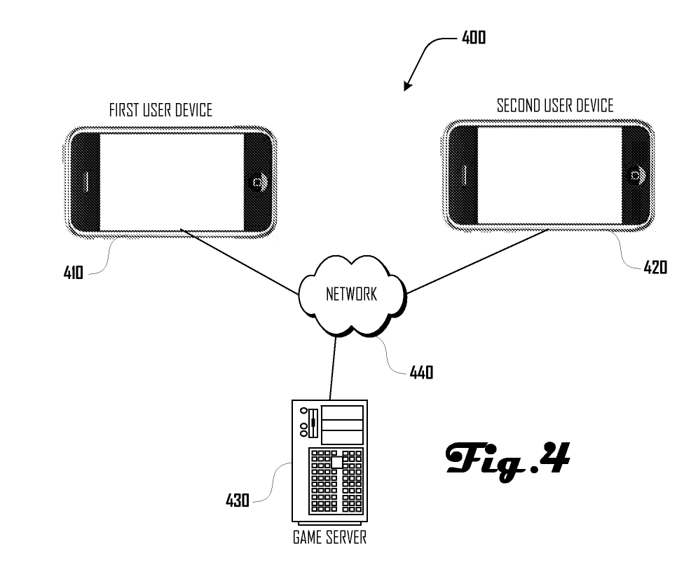

The present disclosure relates to a randomized drawing prompt game, which may be computer implemented or may be played by users without a computer. FIGS. 1-3 relate to an embodiment without computer implementation of the game, and FIGS. 4-6 relate to an embodiment including computer implementation of the game.

FIG. 1 depicts the faces of a six-sided foundation die 110, a six-sided embellishing die 120, and a six-sided orientation die 130 in accordance with one embodiment. These three dice are collectively a random prompt generating set 100. For example, in the embodiment depicted in FIG. 1, the foundational die 110 may include images that correspond to drawing prompts of ‘FRECKLES’, ‘HAIR’, ‘MOUTH’, ‘NOSE’, ‘EARS’, and ‘EYES’. The embellishing die 120 may include images that correspond to drawing prompts of ‘JEWELRY’, ‘HAT’, ‘GLASSES’, ‘NECK ACCESSORY’, ‘FACIAL HAIR’ and ‘EYEBROWS’. The orientation die 130 may include images or words that correspond to drawing prompts of ‘TINY’, ‘TELL ME’, ‘SILLY’, ‘ORDINARY’, ‘BIG’, and ‘ANIMAL’

In an embodiment, a player may roll the three dies 110, 120, 130 to randomly generate a set of three drawing prompts which may prompt the player to create a drawing that corresponds to one or more generated prompts. Additionally, the rolled prompts may determine whether the player will pass his turn or create a drawing corresponding to one or more of the rolled set of prompts.

For example, if a player rolls the three dies 110, 120, 130 and the upturned faces correspond to “SILLY”, “HAIR” and “GLASSES,” this may indicate a prompt to draw, or add to a drawing, hair or glasses that have a silly appearance. For example, such features may be drawn on a face or bust of a character. In an embodiment, the prompts of the foundational die 110 may include prompts related to foundational parts of a body or character. The embellishing die 120 may include prompts that embellish or are worn by a character. The orientation die 130 may include prompts that qualify how the rolled embellishing and foundational prompts should be drawn.

In an embodiment, a given face of a die 110, 120, 130 may correspond to a plurality of drawing prompts. For example, a die 120 having a face depicting jewelry may correspond to drawing prompts for “NECKLACE” and “EARRINGS”. Similarly, a die 120 having a face depicting facial hair may correspond to drawing prompts for “BANGS”, “MOUSTACHE” and “BEARD.” As further discussed herein, in an embodiment, rolling a die 110, 120, 130 to yield a die face that corresponds to a plurality of drawing prompts may allow or require a player to select one of the plurality of drawing prompts.

While embodiments described herein may describe three six-sided dice 110, 120, 130 in various embodiments, dice, coins or other random prompt generating elements may be used to generate a set of randomized drawing prompts. For example, dice of various numbers of faces, a top, a wheel, a coin, set of cards or the like may be used to randomly generate a set of prompts. Additionally, a random prompt generating set 100 may include one or more type of random prompt generator having the same or different numbers of faces or prompt options. In some embodiments, there may be any suitable number of random prompt generators in a random prompt generating set 100. In some embodiments, a computer random number generator may be used to generate a set of prompts.

Additionally, embodiments described herein relate to foundational features of a character face or head and embellishing features that embellish a portion of a character face or head. However, in some embodiments, foundational and embellishing features may relate to other subjects including a character body, a vehicle, building, landscape or other suitable subject with foundational and embellishing features. The example prompts and features discussed herein are merely examples, and should not be construed to be limiting.

Furthermore orientation prompts presented herein are also merely examples, and orientation prompts may include any suitable orientation that describes, qualifies, or inspires aspects of foundational or embellishing features. For example, in an embodiment, orientation prompts may relate to colors, emotions, historical or futuristic time periods, textures, places, movie or television genres, types of music, tastes, sounds, movie or television characters, seasons, or the like.

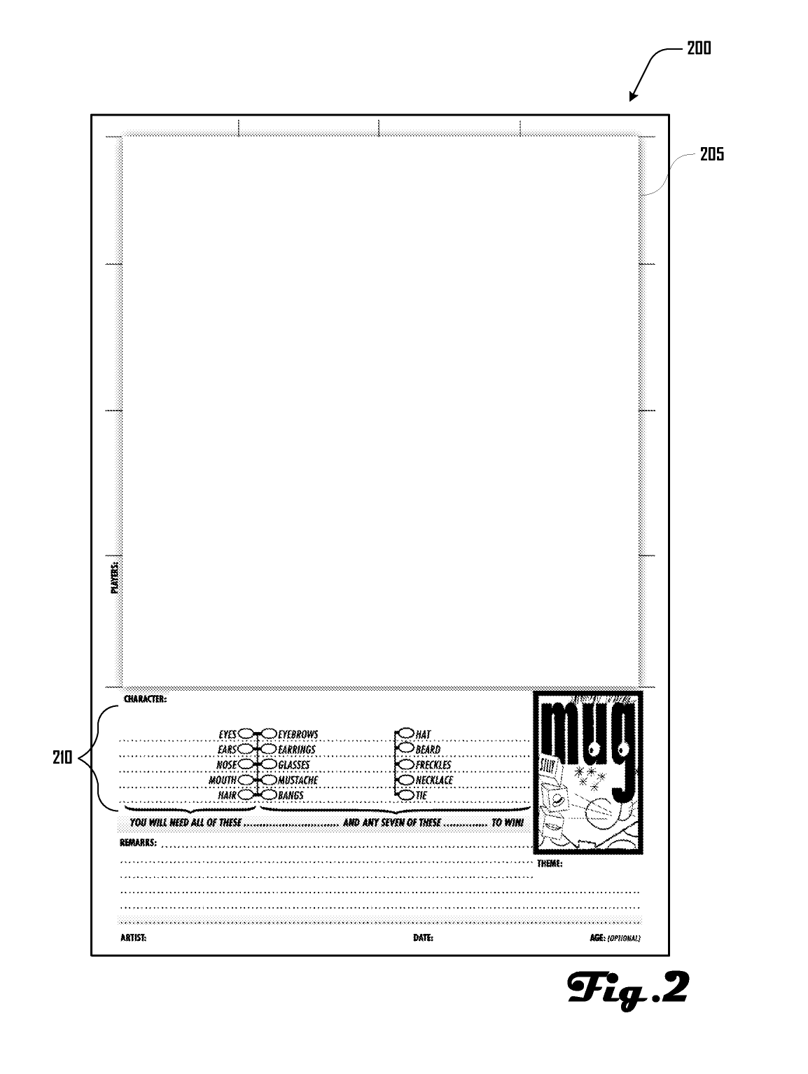

Referring now to FIG. 2, a play-card 200 is depicted which includes a drawing area 205 and a drawn-prompt-score area 210. In an embodiment, each player of a randomized drawing prompt game may have a play-card 200 for creating a drawing in the drawing area 205 and for keeping track of drawn prompts in the drawn-prompt-score area 210.

For example, as further described herein, a player would roll the dies 110, 120, 130; determine and/or select drawing prompts indicate by the dies 110, 120, 130; create or add to a drawing in the drawing area 205 corresponding to the determined and/or selected drawing prompts; and mark the drawn-prompt-score area 210 to indicate which prompts had been drawn.

The drawn-prompt-score area 210 may correspond to game-winning criteria. For example, as depicted in FIG. 2, the game winning criteria are indicated as being 5 of 5 foundational prompts and 7 of 10 embellishing prompts. The drawn-prompt-score area 210 allows a player to keep track of the prompts that she has already draw so as to determine if a given roll of the dies 110, 120, 130 requires that the player pass her turn, if a given roll of the dies 110, 120, 130 allows her to create or add to a drawing in the drawing area 205, if a given roll of the dies 110, 120, 130 makes the player satisfy the defined game-winning criteria, or the like.

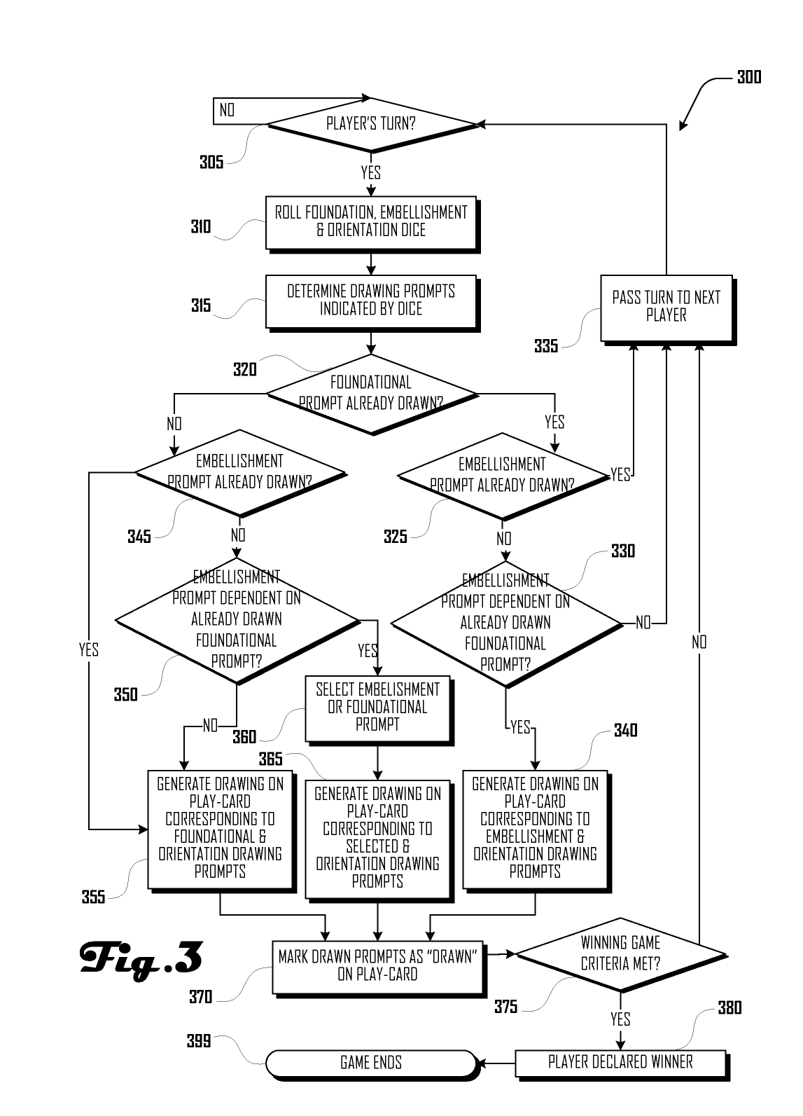

FIG. 3 depicts a method 300 of playing a game having randomized drawing prompts in accordance with an embodiment. The method 300 is described in relation to a single player or team and begins in step 305 where a determination is made whether it is the player's turn. If not, the method 300 cycles until it is the players turn. If it is the player's turn the method 300 continues to step 310 where the player rolls the foundation, embellishing and orientation dice 110, 120, 130 and the drawing prompts indicated by the dice 110, 120, 130 is determined in step 315.

In step 320 a determination is made whether the foundational prompt has already been drawn (which may be determined by consulting the players drawn-prompt-score area 210), and if so, a determination is made in step 325 whether the embellishing prompt has already been drawn (which may be determined by consulting the player's drawn-prompt-score area 210). If the determination from step 325 is that the embellishing prompt has not already been drawn, then in step 330, a determination is made whether the embellishing prompt is dependent on an already drawn foundational prompt. This may be determined by consulting the player's drawn-prompt-score area 210 and an indication of prompt dependence which may be present on the play-card 200 or in a set of game rules. If in step 325 the embellishing prompt has already been drawn or if in step 330 the embellishing prompt is not dependent on an already drawn prompt (but is dependent on a foundational prompt that has not been drawn), then the turn is passed to the next player in step 335. The method 300 then cycles back to step 305 where the player again waits for his turn.

Returning to step 320, if the foundational prompt has not already been drawn, then a determination is made in step 345 whether the embellishing prompt has already been drawn (which may be determined by consulting the player's drawn-prompt-score area 210). If not, in step 350 a determination is made whether the embellishing prompt is dependent on an already drawn foundational prompt. This may be determined by consulting the player's drawn-prompt-score area 210 and an indication of prompt dependence which may be present on the play-card 200 or in a set of game rules.

If in step 350 a determination is made that the embellishing prompt is not dependent on an already drawn foundational prompt, or if in step 345 a determination is made that the embellishing prompt has already been drawn, then in step 355, the player generates a drawing on the play-card 200 (in the drawing area 205) corresponding to the foundational and orientation drawing prompts.

However, if in step 350 a determination is made that the embellishing prompt is dependent on an already drawn foundational prompt, then the player selects one of the embellishing and foundational prompts in step 360 and in step 365, the player generates a drawing on the play card 200 (in the drawing area 205) corresponding to the orientation drawing prompt and the selected drawing prompt (either foundational or embellishing).

Returning to step 330, if a determination is made that the embellishing prompt is dependent on an already drawn foundational prompt, then the player generates a drawing on the play-card 200 (in the drawing area 205) corresponding to the embellishing and orientation drawing prompts.

For example, a player rolls the dice 110, 120, 130 to randomly generate prompts that will be characteristic of a drawing that she will create, or to determine that she must pass her turn to another player. The player must pass if both the rolled embellishing feature(s) and the rolled foundational feature(s) have already been drawn by the player during the game. Or if the foundational feature(s) rolled have already been played, and if the embellishing feature(s) depend on a foundational feature that has not already been drawn. For example, drawing embellishing earring may first require that the player have first drawn ears, so the embellishing earrings would be considered to be depended upon the foundational ears.

In an embodiment, the player must select one of the rolled foundational prompt(s) or the rolled embellishing prompt(s) and make a drawing corresponding to the orientation prompt and the selected foundational or embellishing prompt. However, a player may not select a rolled foundational feature if it has already been drawn, and cannot draw a rolled embellishing feature if the foundational feature from which the embellishing feature depends has not already been drawn. If the player is unable to select one of the rolled foundational or embellishing prompts, then the player must pass as discussed above.

Referring back to the method 300 of FIG. 3, once the player has generated a drawing in steps 355, 365 or 340, the player marks the prompts as ‘DRAWN’ on the play-card in step 370. In step 375, a determination is made whether the winning game criteria are met, and if so, the player is declared the winner of the game in step 380 and the game ends in step 399. However, if the winning game criteria are not yet met, then the turn is passed to the next player in step 335.

For example, the player may mark the drawn-prompt-score area 210 so as to indicate that the recently drawn prompt was drawn. In an embodiment, a player may only need to mark foundational or embellishing prompts because only foundational or embellishing prompts may be part of the winning-game criteria. However, a player may choose to indicate in the drawn-prompt-score area 210 which orientation prompt was used when a given foundational or embellishing prompt was drawn. In some embodiments, game winning criteria may include one or more of foundational, embellishing or orientation prompts, and a player may mark the drawn-prompt-score area 210 to indicate that one or more of foundational, embellishing or orientation prompts were rolled and used in a drawing turn.

While the above example embodiment disclosed in relation to FIG. 3 may require that each embellishing prompt is dependent on at least one foundational prompt, in various embodiments, there may be alternative relationships between foundational and embellishing prompts.

For example, in an embodiment (e.g., FIG. 1) prompts such as “HAT”, “BEARD”, “FRECKLES”, “NECKLACE” and “TIE” may not be dependent upon a foundational prompt. In this example, a face having a head and neck may be a given feature, and therefore no foundational prompt would first be required to allow such an embellishing prompt to be drawn. In gameplay, if a player rolls an embellishing prompt that does not depend on a foundational prompt, then the player may choose to draw the embellishing prompt (assuming it has not already been drawn). Accordingly, in an embodiment, gameplay may include a determination whether a rolled embellishing prompt depends on a foundational prompt.

In addition to one or more embellishing prompt not depending on any foundational prompt, in some embodiments, an embellishing prompt may depend on a plurality of foundational prompts. For example, an embellishing prompt “EARRINGS” may depend on foundational prompts “LEFT EAR” and “RIGHT EAR.”

In some embodiments, a plurality of embellishing prompts may depend on the same foundational prompt. For example, embellishing prompts for “NECKLACE” and “TIE” may depend from a foundational prompt of “NECK.”

Some embodiments may include additional game features or elements. For example, one embodiment may include a bell for indicating a turn. One embodiment may include a deck of cards that includes examples of images drawn that correspond to one or more prompt. Another embodiment may include a container for storing and rolling the random prompt generating set 100. Some embodiments may include dramatization or creative writing elements. Further embodiments may include players switching play cards 200 for one or more turn. Still further embodiments include a single player, and the single player may produce images based on books or magazines.

FIGS. 4-6 depict computer implemented systems, methods and communications for playing a randomized drawing prompt game in accordance with an embodiment. FIG. 4 depicts a randomized drawing prompt game system 400 having a first and second user device 410, 420 and a game server 430 that are operably connected via a network 440. User devices may be various devices including a computer, smart phone, tablet computer, laptop, gaming system or other suitable device. The network 440 may be the internet or may be any other suitable network including a wireless network, local-area network, or the like. The game server 430 may be any suitable device such as a web-server or personal computer.

While FIG. 4 depicts two user devices, some embodiments may include one or more user devices and one or more players. In some embodiments multiple players may be associated with a single user device 410, 420 playing as individual players or as a team.

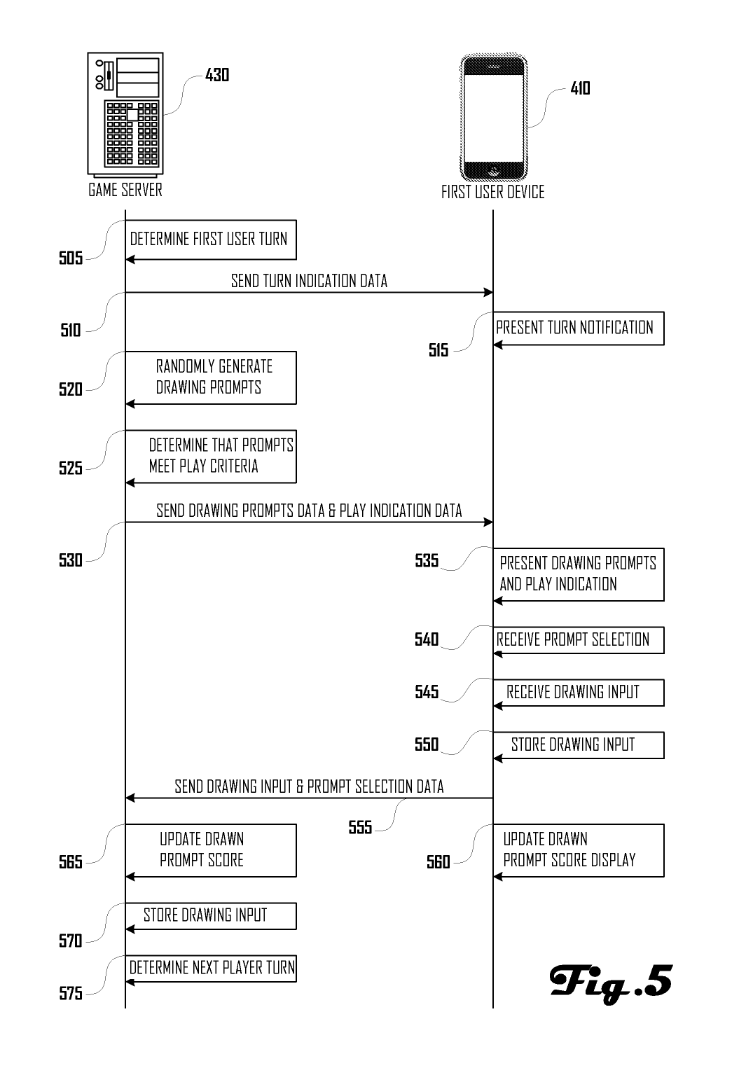

FIG. 5 is a data-flow diagram depicting an example of a series of communications that occur between a game server 430 and a first user device 410 during a randomized drawing prompt game in accordance with one embodiment. The communications begin where a first user turn is determined 505 and the game server 430 sends 510 a turn indication to the first user device 410, which presents 515 the turn notification. For example, where there is a plurality of players on a plurality of user devices 410, 420 turns may be passed between the players as discussed herein. When a player associated with the first user device 410 has a turn, the user device 410 may indicate via a display, sound or the like that it is a given player's turn.

The communications continue where the game server randomly generates 520 a set of drawing prompts and determines that the generated 520 prompts meet play criteria. For example, as discussed above, foundational, embellishing and orientation prompts may be randomly generated (instead of being randomly generated by a set of dies 100). As further discussed above, if the set of generated prompts meet criteria that allow the player to play the turn instead of pass (e.g., a foundational prompt has not been drawn and/or an embellishing prompt has not been drawn and is dependent upon a foundational prompt that has already been drawn), the game server 430 determines that the player can therefore play the turn and sends 530 an indication of the generated 520 drawing prompts and an indication that the player may play the turn.

The user device 410 presents the indicated drawing prompts and a play indication. For example, the user device may present a graphic reading “YOU ROLLED [X, Y, and Z]—GET READY TO DRAW!”

The user device 410 receives 540 a prompt selection, receives 545 drawing input, and stores 550 drawing input data. For example, in a roll that provides an opportunity to select between a rolled foundational or embellishing prompt(s), a player may input a selection via the user device 410. In another example, where a given rolled prompt provides for a selection of one or more further prompt (e.g., a facial hair prompt that allows for selection of beard, moustache, or bangs), a user may also input this selection via the user device 410. In an embodiment, one or more selection may be input and received 545 by the user device 410.

A player may input a drawing on a user device 410 via any suitable interface, which may include a touch screen, a keypad, a track ball, a mouse, a stick, via physical gestures, or the like. Selections may be similarly input.

The user device 410 sends 555 the drawing input data and prompt selection data to the game server 430 and the first user device 410 updates a drawn-prompt-score display on the user device 410, and the game server updates 565 the player's drawn prompt score data, stores 570 the drawing input data, and determines 575 the next player's turn.

The drawing input data may be stored on both the user device 410 and game server 430, and may be used for various purposes. Drawing input data may be shared with and displayed on other user devices (e.g., the second user device 420) in real time or periodically. For example, when a first player is drawing during a first player turn, the second user device 420 may display the drawing as it occurs. This may be desirable because players that are not playing a turn may still be engaged and entertained by the game. Additionally, drawing data may also be shared (e.g., via Facebook, Flickr, Instagram or the like).

As discussed above, progressive drawn-prompt score data may be used to determine if a given set of generated prompts allows a user to play a turn, and the game server 430 may store drawn-prompt score data for each player and use it to determine pass and play turns for players. Additionally, a drawn-prompt score may be displayed on a user device during gameplay for a player's reference. A drawn-prompt score may be stored in a memory and periodically updated.

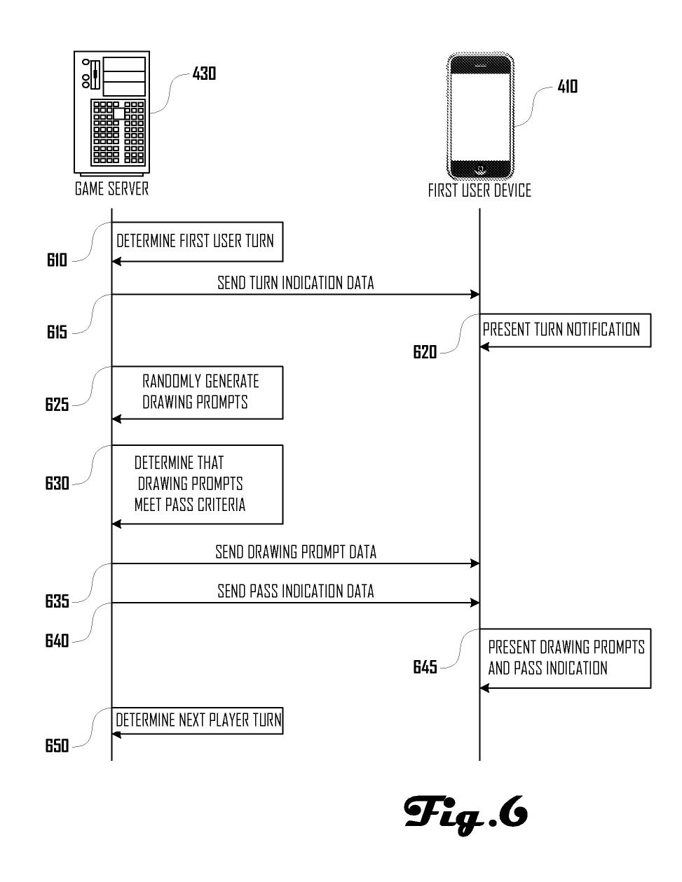

FIG. 6 is a data-flow diagram depicting an example of a series of communications that occur between a game server 420 and a first user device 410 during a randomized drawing prompt game in accordance with one embodiment where a player's turn is determined to be a passing turn. The game server 430 determines 610 that it is the first player's turn and sends 615 turn indication data to the first user device 410, which presents 620 a turn notification. The game server 430 randomly generates 625 a set of drawing prompts and determines 630 that the drawing prompts meet pass criteria. The game server 430 sends 635 drawing prompt data and sends 640 pass indication data to the first user device 410, which presents 645 an indication of drawing prompts and a pass indication. The game server 430 then determines 650 the next player turn.

While the above example embodiment disclosed in relation to FIGS. 5 and 6 may require that each embellishing prompt is dependent on at least one foundational prompt, in various embodiments, there may be alternative relationships between foundational and embellishing prompts as discussed herein. In some embodiments, one or more embellishing prompt may not be dependent upon any foundational prompt. In some embodiments, one or more embellishing prompt may depend on one foundational prompt. In some embodiments, an embellishing prompt may depend on one or more foundational prompt.

Accordingly, from the foregoing it will be appreciated that, although specific embodiments have been described herein for purposes of illustration, various modifications may be made without deviating from the spirit and scope of the disclosure. Furthermore, where an alternative is disclosed for a particular embodiment, this alternative may also apply to other embodiments even if not specifically stated.

1. A method of game play, comprising:
determining that it is the turn of a first player;
randomly generating a set of drawing prompts comprising:
one or more foundational prompts,
one or more embellishing prompts, and
an orientation prompt;
determining whether any of the one or more currently generated embellishing or foundational prompts were generated in a previously generated set of drawing prompts during a first player turn;
ending the first player's current turn
if all of the one or more currently generated embellishing and all of the one or more currently generated foundational prompts were generated in a previously generated set of drawing prompts during a previous first player turn;
ending the first player's current turn
if all of the one or more currently generated foundational prompts were generated in a previously generated set of drawing prompts during a previous first player turn, and
where all of the one or more currently generated embellishing prompts depend on a foundational prompt that was not generated in a previously generated set of drawing prompts during a previous first player turn;
generating a drawing corresponding to at least one of the one or more currently generated embellishing prompts and the currently generated orientation prompt
if all of the one or more currently generated foundational prompts was generated in a previously generated set of drawing prompts during a previous first player turn,
where at least one of the one or more currently generated embellishing prompts was not generated in a previously generated set of drawing prompts during a previous first player turn, and
where the at least one currently generated embellishing prompt depends on a foundational prompt that was generated in a previously generated set of drawing prompts during a previous first player turn or where the at least one currently generated embellishing prompt does not depend on a foundational prompt;
generating a drawing corresponding to at least one of the one or more currently generated foundational prompts and the currently generated orientation prompt
where all of the one or more currently generated embellishing prompts were generated in a previously generated set of drawing prompts during a previous first player turn, and
where at least one of the one or more currently generated foundational prompts was not generated in a previously generated set of drawing prompts during a previous first player turn,
generating a drawing corresponding to a selected at least one of the one or more currently generated foundational prompts or a selected at least one of the one or more currently generated embellishing prompt and corresponding to the currently generated orientation prompt
where at least one of the one or more currently generated foundational prompts was not generated in a previously generated set of drawing prompts during a previous first player turn,
where at least one of the one or more currently generated embellishing prompts was not generated in a previously generated set of drawing prompts during a previous first player turn, and
where the at least one currently generated embellishing prompt depends on a foundational prompt that was generated in a previously generated set of drawing prompts during a previous first player turn or where the at least one currently generated embellishing prompt does not depend on a foundational prompt.

2. The method of claim 1, further comprising determining if the set of drawing prompts generated in the first players current turn and in previous first player turns meets winning criteria.

3. The method of claim 2, further comprising ending the first player's current turn after a drawing has been generated and where winning criteria have not been met.

4. The method of claim 3, further comprising one of initiating a turn of a second player and initiating a subsequent turn of the first player when the first player's turn is ended.

5. The method of claim 1, wherein generating a drawing comprises a player drawing on a play-card.

6. The method of claim 1, wherein generating a drawing comprises a user providing a drawing input on a user device.

7. The method of claim 1 further comprising updating a first user drawn prompt score.

8. The method of claim 7, wherein updating the first user drawn prompt score comprises marking a play-card.

9. The method of claim 7, wherein updating the first user drawn prompt score comprises storing an updated first user drawn prompt score in a memory.

10. The method of claim 1, wherein randomly generating a set of drawing prompts comprises rolling three dice, wherein one die is associated with a plurality of foundational prompts, wherein one die is associated with a plurality of embellishing prompts, and wherein one die is associated with a plurality of orientation prompts.

11. The method of claim 10, wherein each of the three dice are six-sided.

12. The method of claim 1, wherein randomly generating a set of drawing prompts comprises using a computer random number generator.

13. The method of claim 1, wherein the foundational and embellishing drawing prompts are associated with at least one of a part of a head bust or an embellishment of a head bust.

14. A game comprising:
a set of foundational drawing prompts;
a set of embellishing drawing prompts with at least one of the embellishing prompts being dependent on at least one of the foundational prompts; and
a set of orientation drawing prompts, each operable to provide an orientation to any of the foundational and embellishing drawing prompts when paired with any of the foundational or embellishing drawing prompts.

15. The game of claim 14,
wherein each of the foundational drawing prompts are defined on a face of a foundational die;
wherein each of the embellishing drawing prompts are defined on a face of an embellishing die; and
wherein each of the orientation drawing prompts are defined on a face of an orientation die.

16. The game of claim 14, further comprising a play-card comprising a drawing area.

17. The game of claim 16, wherein the play-card further comprises a drawn-prompt-score area configured to provide for tracking drawing prompts associated with drawings generated in the drawing area.

18. The game of claim 14, wherein the foundational and embellishing drawing prompts are associated with at least one of a part of a head bust or an embellishment of a head bust.
